(19) United States
(12) Patent Application Publication
(10) Pub. No.: US 2012/0017169 A1
(43) Pub. Date: Jan. 19, 2012

(54) System and method of dividing a window according to trail

(75) Inventors: Chaucer Chiu, Taipei (TW); Sean Liu, Shanghai (CN)

(73) Assignee: INVENTEC CORPORATION, Taipei (TW)

(21) Appl. No.: 12/805,979

(22) Filed: Aug. 27, 2010

(30) Foreign Application Priority Data
Jul. 16, 2010 (TW) 099123448

(51) Int. Cl. G06F 3/048

(52) U.S. Cl. 715/784; 715/788

(57) ABSTRACT

System and method of dividing a window according to trail are provided. The system and the method record the moving trail of an indicating signal and then divide the window according to the moving trail into two independent blocks to display the file separately. By completing the procedures, the system and the method enable a user to divide a window according to a user-defined direction, and therefore further enhance the contrast effect between different parts of a file.

### BACKGROUND OF THE INVENTION

1. Field of Invention

The invention relates to a window dividing system and the method thereof. In particular, the invention pertains to system and method of dividing a window according to a moving trail of an indicating signal.

2. Related Art

With the evolution of computer operating systems, conventionally pure text operating platforms have been quickly replaced by a versatile graphic user interface (GUI) that is much easier to use. Although one still has to use a text operating platform for entering system commands under some development requirements or special circumstances, most people are still more accustomed to the GUI with graphic elements of the mouse cursor, windows, menus, and icons. Since the data or utilities in the GUI are conventionally displayed in units of window blocks, a single window block corresponds to one set of displayed data. When a user needs to make a comparison within one set of data, he has to first scroll and remember the parts to compare and then determine the comparison result by himself. This method may be easy to accomplish when the data is in small quantity. Once there are a lot of data, this method can be cumbersome for the user.

To solve the problem that a single window block corresponds to a single set of displayed data, computer software manufacturers have invented a method to drag a predetermined dividing line to divide the window block horizontally or vertically. A single window block can thus be divided into two for the user to compare data within a single set of data. The user only needs to scroll the displayed data in the two window blocks to the positions for comparison. Therefore, the user does not need to remember a huge amount of data in order to accomplish the comparison.

However, the above-mentioned method divides the window according to the predetermined dividing line dragged by the user horizontally or vertically. In some circumstances, the user may want to define the dividing scheme by himself. For example, when the user is editing pictures, he may hope to divide the window diagonally in order to contrast colors. Or when the user is working on text and wants to edit the indentation and spacing of a particular paragraph, he may hope to divide the window into two trapezoids for comparison. The conventional window dividing system and method do not provide such functions. It is therefore desirable to provide a better solution.

### SUMMARY OF THE INVENTION

In view of the foregoing, the invention provides system and method of dividing a window according to trail.

The disclosed system includes: a receiving module for receiving a starting signal of starting a window division and an indicating signal; a recording module for recording a moving trail traced by the indicating signal from a first point on a first edge of a window block to a second point on a second edge and for recording the current display position of the displayed data in the window block, copying the displayed data, and computing and recording the initial display positions of the displayed data after the window block is divided into a first block and a second block according to the moving trail and the current display position; a dividing module for dividing the window block into the first block and the second block according to the moving trail; and a displaying module for displaying the copied displayed data according to the initial display positioned of the displayed data in the first block and the second block.

In the disclosed system, the indicating signal is the moving signal of the mouse cursor in the GUI or the touch and moving signal of a touch-control device. The dividing module further uses the first block and the second block to generate independent threads according to the program running in the window block. The dividing module also generates scrolling elements for the data in the first block and the second block. The first block and the second block are can be further treated as independent window blocks and divided into multiple blocks.

The disclosed method includes the steps of: receiving a starting signal for starting a window division; recording a moving trail traced by an indicating signal from a first point on a first edge to a second point on a second edge; recording the current position of the displayed data in the window block and copying the displayed data; dividing the window block into a first block and a second block according to the moving trail; computing and recording the initial display positions of the displayed data in the first block and the second block according to the moving trail and the current display position; and displaying the copied displayed data according to the initial display positions of the displayed data in the first block and the second block.

In the disclosed method, the indicating signal is the moving signal of the mouse cursor in the GUI or the touch and moving signal of a touch-control device. The step of displaying the copied displayed data according to the initial display positions of the displayed data in the first block and the second block is preceded by the step of using the first block and the second block to generate independent threads according to the program running in the window block. Moreover, the step of displaying the copied displayed data according to the initial display positions of the displayed data in the first block and the second block is preceded by the step of generating scroll elements for the data in the first block and the second block. The method can also include the step of further dividing the first block and the second block into multiple blocks by treating them as independent window blocks.

As described above, the disclosed system and method differ from the prior art in that by recording the moving trail of the indicating signal, the invention divides the displayed data in the window block into two independent blocks to display the data separately according to the moving trail.

By completing the procedures, the system and the method enable a user to divide a window according to a user-defined direction, and therefore further enhance the contrast effect between different parts of a file.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed system of dividing a window according to trail;

FIG. 2 is a flowchart of the disclosed method of dividing a window according to trail;

FIG. 3 is a schematic view of the moving trail of the indicating signal according to an embodiment of the invention;

FIGS. 4A and 4B are schematic views of the divided window blocks in the embodiment; and

FIG. 5 is a schematic view of dividing a window block into multiple blocks in the embodiment.

### DETAILED DESCRIPTION OF THE INVENTION

The present invention will be apparent from the following detailed description, which proceeds with reference to the accompanying drawings, wherein the same references relate to the same elements.

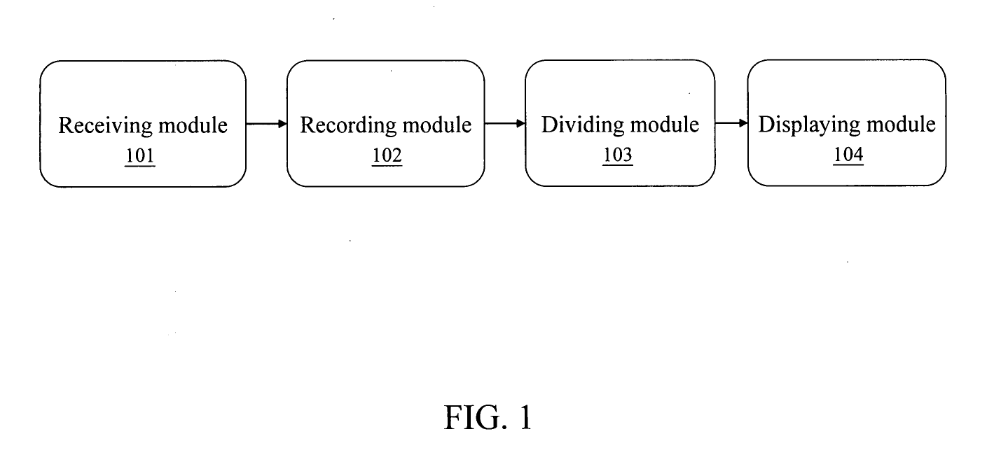

FIG. 1 is a block diagram of the disclosed system of dividing a window according to trail. The disclosed system is a window dividing system. In particular, the system divides a window according to the moving trail of an indicating signal. It includes a receiving module 101, a recording module 102, a dividing module 103, and a displaying module 104.

The receiving module 101 receives a starting signal for starting a window division and receives an indicating signal. The window block referred herein is a basic unit for displaying data or programs in a GUI. When a user runs the program, he can decide whether to divide the window block for comparison. Once the user selects the dividing function, the receiving module 101 receives the starting signal. The receiving module 101 also starts to receive the indicating signal.

It should be noted that the indicating signal is the moving signal of the mouse cursor in the GUI or the touch and moving signal of a finger or touch-control pen on the surface of a touch-control device. Under normal conditions, the GUI has a mouse cursor. Therefore, the user can use a mouse or a touch-control device to control the mouse cursor. In some particular touch-control computers or mobile phones, the GUI may not have a mouse cursor. In that case, the user directly uses his finger or touch-control pen to operate on the touch-control surface. The touching point is the starting point, and the leaving point is the finishing point. The indicating signal is thus produced.

The recording module 102 records a moving trail traced by the indicating signal from a first point on a first edge of the window block to a second point on a second edge thereof. After the receiving module 101 receives the starting signal and the indicating signal, the recording module 102 starts to record the moving trail of the indicating signal. It should be noted that the first edge and the second edge of the window block are different edges. The recording module 102 starts to record the moving trail when the indicating signal touches the first edge and stops when the indicating signal touches the second edge.

In addition to recording the moving trail, the recording module 102 also records the current display position of the displayed data in the window block. At the same time, it copies all the contents of the displayed data.

The dividing module 103 follows the moving trail recorded by the recording module 102 to divide the window block into a first block and a second block. It should be noted that in addition to dividing the image at the current display position, the dividing module 103 also uses the first block and the second block to generate independent threads according to the program running in the window block. The threads refer to executing entities of a same program function that can manipulate the same set of data. For example, a text editing window is divided by the dividing module 103 into two threads that can edit the same document concurrently. The editing action done by the user under any thread is then updated to the same document in both blocks. After the dividing module generates threads for the divided blocks, it also generates individual scroll elements for the blocks. The scroll element can be a scroll bar in usual windows or any user-defined graphic element that can manipulate the moving direction of data image.

The dividing module 103 divides the window block into a first block and a second block. The recording module 102 computes and records the initial display positions of the displayed data in the divided first block and second block according to the moving trail and the current display position. For example, suppose the user is editing text and needs to compare the indentations of various lines on page 5. He can use the indicating signal to produce a slant moving trail from the upper left side to the lower right side in the rectangle window block. The dividing module 103 then divides the window block into left and right trapezoid blocks according to the slant line. The initial display positions of the displayed data in the left and right trapezoid blocks are also recorded so that the new displays still start from page 5. This avoids the situation where the displayed data in the left trapezoid starts from page 1 whereas the one in the right trapezoid starts from page 5, for example. Therefore, the user can divide the window block according to a self-defined way to enhance the contrast effect of data. Since the moving trail can be a slant line, a straight line, a zigzag line, or an arbitrary curve defined by the user, the initial display position may vary as well. The invention does not impose any restriction on the calculating method for the initial display position.

The displaying module 104 displays the copied displayed data at the initial display positions of the first block and the second block, respectively. After the recording module 102 records the initial display positions of the displayed data in the first block and the second block and the displaying module 104 displays the copied displayed data separately, the displayed data do not start from the first page. The displayed data in the first block starts from lines 1 to 10 on page 2, and the displayed data in the second block starts from lines 11 to 20 on page 2.

In addition, it should be noted that in addition to dividing a window block into two blocks, the disclosed system of diving a window according to trail can further treat the blocks as independent window blocks and divide them into more blocks. The invention does not restrict the number of blocks thus produced.

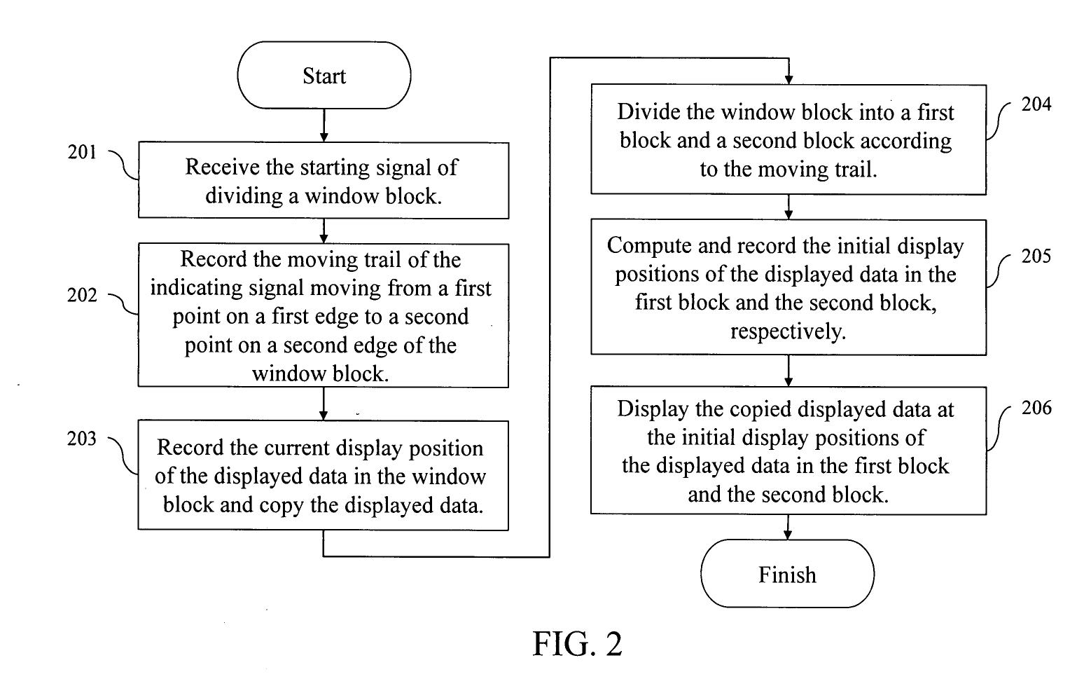

FIG. 2 is a flowchart of the disclosed method of dividing a window according to trail.

First, a starting signal for starting a window division is received (step 201). The window block is a basic unit for displaying data or programs in a GUI. When a user runs a program, he can choose whether to divide and contrast the window block. Once the user selects the dividing function, a starting signal is received.

Afterwards, the moving trail of the indicating signal traversing the window block from a first point on a first edge to a second point on a second edge is recorded (step 202). The first edge and the second edge of the window block are different sides. The recording of the indicating signal starts when the indicating signal touches the first edge and ends when the indicating signal touches the second edge.

It should be noted that the indicating signal is the moving signal of the mouse cursor in the GUI or the touch and moving signal of a finger or touch-control pen on the surface of a touch-control device. Normally, the GUI has a mouse cursor. Therefore, the user can use the mouse or a touch-control device to control the mouse cursor. However, in some touch-control computer or mobile phone, the GUI may not have a mouse cursor. The user directly uses his finger or touch-control pen to operate on a touch-control surface. The touching point is the starting point, and the leaving point is the finishing point. The indicating signal is thus generated.

Step 203 records the current display position of the displayed data in the window block and copies the displayed data. The window block is divided according to the moving trail into a first block and a second block (step 204). It should be noted that in addition to dividing the image at the current display position, the method also uses the first block and the second block to generate independent threads according to the program running in the window block. The threads refer to executing entities of a same program function that can manipulate the same set of data. For example, a text editing window is divided by the dividing module 103 into two threads that can edit the same document concurrently. The editing action done by the user under any thread is then updated to the same document in both blocks. After the dividing module generates threads for the divided blocks, it also generates individual scroll elements for the blocks. The scroll element can be a scroll bar in usual windows or any user-defined graphic element that can manipulate the moving direction of data image.

Step 205 computes and records the initial display positions of the displayed data in the first block and the second block according to the moving trail and the current display position. For example, suppose the user is editing text and needs to compare the indentations of various lines on page 5. He can use the indicating signal to produce a slant moving trail from the upper left side to the lower right side in the rectangle window block. The method then divides the window block into left and right trapezoid blocks according to the slant line. The initial display positions of the displayed data in the left and right trapezoid blocks are also recorded so that the new displays still start from page 5. This avoids the situation where the displayed data in the left trapezoid starts from page 1 whereas the one in the right trapezoid starts from page 5, for example. Therefore, the user can divide the window block according to a self-defined way to enhance the contrast effect of data. Since the moving trail can be a slant line, a straight line, a zigzag line, or an arbitrary curve defined by the user, the initial display position may vary as well. The invention does not impose any restriction on the calculating method for the initial display position.

Finally, step 206 displays the copied displayed data according to their initial display positions in the first block and the second block. Thus, the copied displayed data are not necessarily shown from page 1.

It should be noted that in addition to dividing a window block into two blocks, the disclosed method of diving a window according to trail can further treat the blocks as independent window blocks and divide them into more blocks. The invention does not restrict the number of blocks thus produced.

In the following, an embodiment of applying the invention to a text editing program is used to explain the invention in detail.

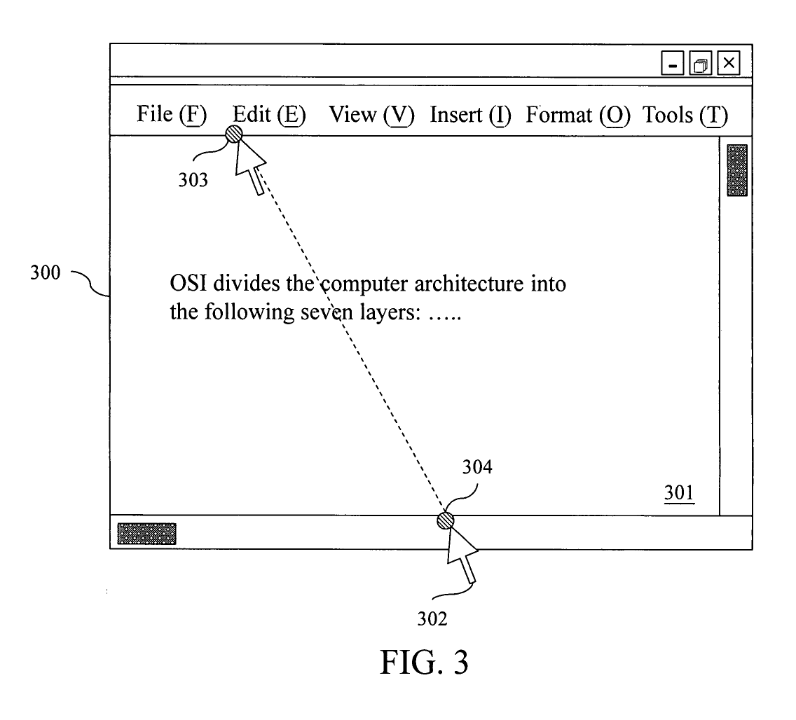

Please refer to FIG. 3. Suppose there is a text editing program window 300. The displayed data are shown in the window block 301. When the user selects the window dividing function, the text editing program receives a starting signal for dividing the window block 301. If the user moves the mouse cursor 302 from a first point 303 on one side of the window block 301 to a second point 304, the moving trail of the mouse cursor 302 is recorded. Suppose the moving trail of the mouse cursor 302 is shown by the dashed line in FIG. 3. After the moving trail is recorded, the text editing program records the current position of the displayed data in the window block 301, and copies all the contents of the displayed data. In this embodiment, the moving trail is a slant line as an example. In reality, the moving trail can be a zigzag line, wavy line, straight line, or any curve defined by the user. The invention does not restrict the style of the moving trail.

It should be noted that even though this embodiment uses the mouse cursor 302 as the indicating signal to record the moving trail, some particular touch-control computer or mobile phone may not have a mouse cursor in the GUI. In this case, the user directly uses his finger or touch-control pen to operate on the touch-control surface. The touching point is the starting point, and the leaving point is the finishing point. The indicating signal is thus generated. The invention is not restricted only to the example of mouse cursor 302.

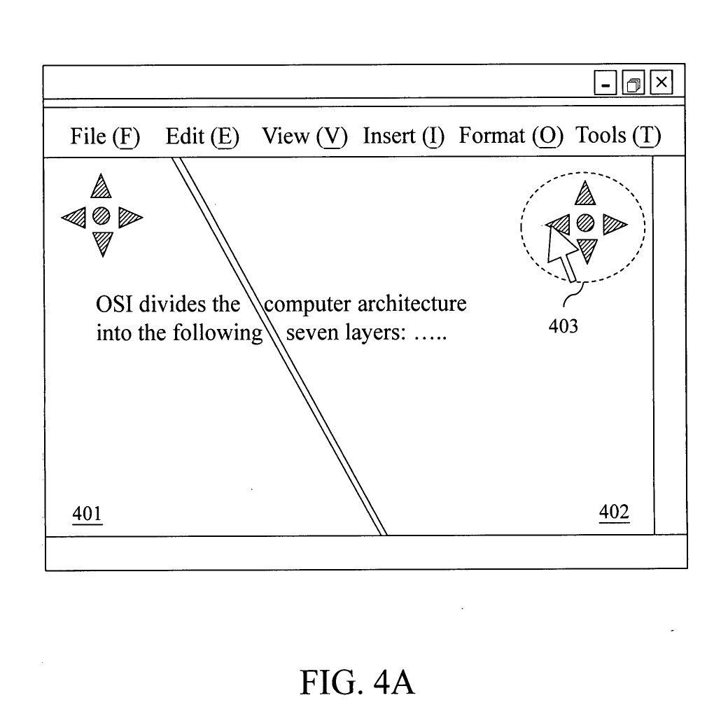

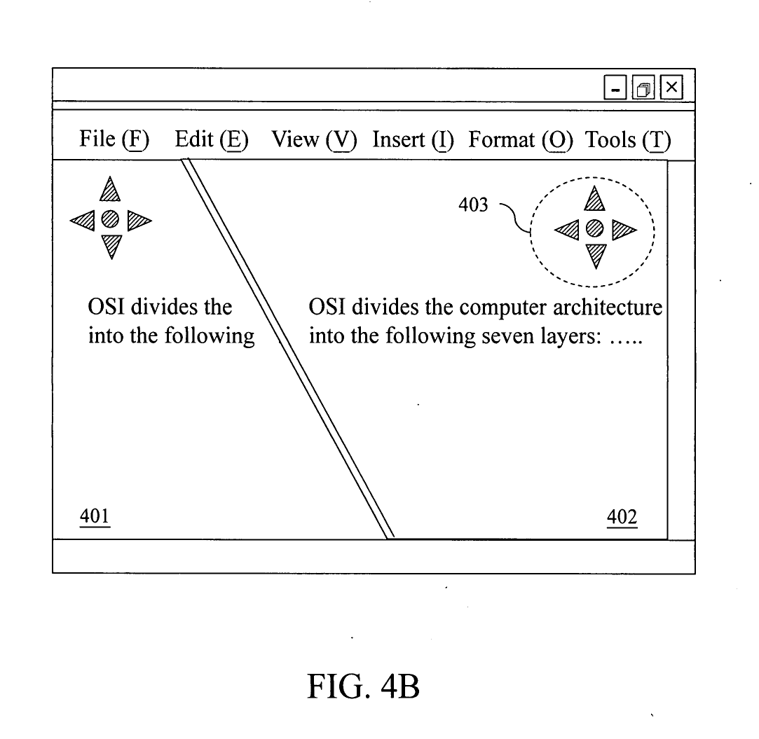

After recording the moving trail of the mouse cursor 302, the window block 301 is divided according to the moving trail. The divided window block 301 has a first block 401 and a second block 402, as shown in FIG. 4A. Afterwards, the moving trail and the current display position are used to compute and record the initial display positions of the displayed data respectively in the first block 401 and the second block 402. The copied displayed data are then displayed at the initial display positions in the first block 401 and the second block 402, respectively.

It should be noted that the text editing program can generate two threads according to the first block 402 and the second block 402. Therefore, no matter which block is edited by the user, the data can be updated to the same displayed data. Besides, scroll elements 403 can be generated in the first block 401 and the second block 402. By operating the scroll elements 403, the user can adjust the display position of the displayed data in the selected block. For example, suppose the user uses the scroll element 403 in the second block 402 to move the displayed data to the left. The shifted result is as the second block 402 shown in FIG. 4B.

The scroll element 403 can be a scroll bar in the usual window or any graphic element defined by the user to move the data. The invention does not restrict the style of the scroll element 403.

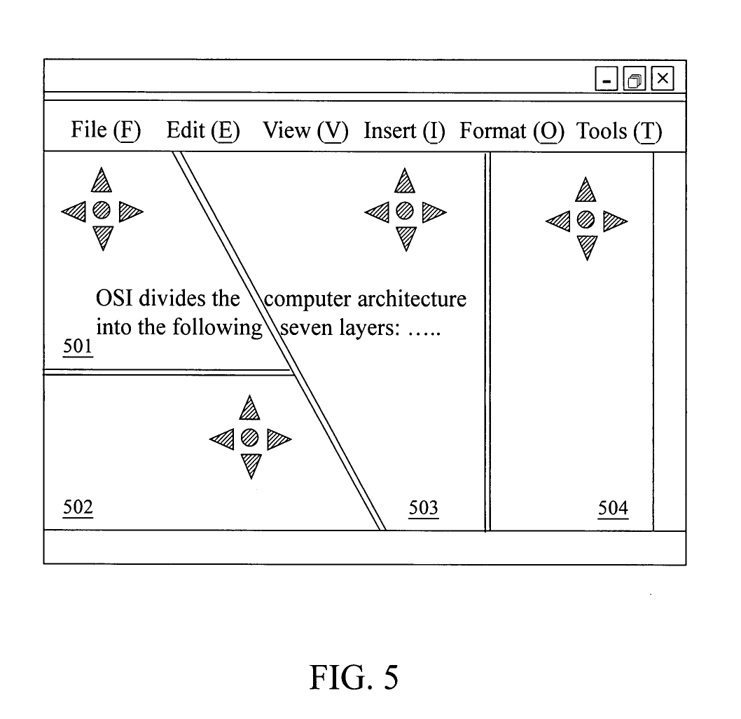

Moreover, the first block 401 and the second block 402 after the division can be independent window blocks and further divided. As shown in FIG. 5, the same window block can be divided into multiple blocks 501-504 using the same method. There are many dividing methods, on which the invention does not impose any restriction.

In summary, the invention differs from the prior art in that after recording the moving trail of an indicating signal, the displayed data in a window block is divided into two independent blocks according to the moving trail to display the data separately. By completing the procedures, the system and the method enable a user to divide a window according to a user-defined direction, and therefore further enhance the contrast effect between different parts of a file.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system of diving a window according to trail, comprising:
a receiving module for receiving a starting signal of dividing a window block and for receiving an indicating signal;
a recording module for recording a moving trail of the indicating signal traversing from a first point on a first edge to a second point on a second edge, and for recording a current display position of displayed data in the window block, copying the displayed data, and computing and recording initial display positions of the displayed data in a first block and a second block obtained by dividing the window block according to the moving trail and the current display position;
a dividing module for dividing the window block into the first block and the second block according to the moving trail; and
a displaying module for displaying the copied displayed data respectively at the initial display positions in the first block and the second block.

2. The system of claim 1, wherein the indicating signal is the signal of a mouse cursor moving in a graphic user interface (GUI) or a touch and moving signal in a touch-control device.

3. The system of claim 1, wherein the dividing module uses the first block and the second block to generate independent threads according to the program running in the window block.

4. The system of claim 3, wherein the dividing module generates a scroll element for the data in the first block and the second block, respectively.

5. The system of claim 1, wherein the first block and the second block are taken as independent window blocks and further divided into more blocks.

6. A method of dividing a window according to trail, comprising the steps of:
receiving a starting signal for dividing a window block;
recording a moving trail of an indicating signal traversing the window block from a first point on a first edge to a second point on a second edge;
recording a current display position of displayed data in the window block and copying the displayed data;
dividing the window block into a first block and a second block according to the moving trail;
computing and recording the initial display positions of the displayed data in the first block and the second block respectively according to the moving trail and the current display position; and
displaying the copied displayed data at the initial display positions in the first block and the second block.

7. The method of claim 6, wherein the indicating signal is the signal of a mouse cursor moving in a graphic user interface (GUI) or a touch and moving signal in a touch-control device.

8. The method of claim 6 further comprising the step of using the first block and the second block to generate independent threads according to the program running in the window block before the step of displaying the copied displayed data at the initial display positions in the first block and the second block.

9. The method of claim 8 further comprising the step of generating a scroll element for the data in the first block and the second block, respectively, before the step of displaying the copied displayed data at the initial display positions in the first block and the second block.

10. The method of claim 6 further comprising the step of dividing the first block and the second block, which are taken as independent window blocks, into more blocks.
